(19) United States
(12) Patent Application Publication
(10) Pub. No.: US 2010/0171432 A1
(43) Pub. Date: Jul. 8, 2010

(54) METHOD AND APPARATUS FOR PREVENTING INTRUSION

(75) Inventor: Johan Sandberg, Stockholm (SE)

Correspondence Address: DOWELL & DOWELL P.C., 103 Oronoco St., Suite 220, Alexandria, VA, 22314, US

(73) Assignee: INDUSEC AB, TABY (SE)

(21) Appl. No.: 12/451,217

(22) PCT Filed: Apr. 29, 2008
(86) PCT No.: PCT/SE2008/050494

§ 371 Date: Mar. 16, 2010

(30) Foreign Application Priority Data
May 3, 2007 (SE) 0701062-2

(51) Int. Cl. H05B 37/02

(52) U.S. Cl. 315/210

(57) ABSTRACT

A method of controlling one or more light sources for preventing unauthorized intrusion or/and staying within an area outdoors or indoors, for example in a building, in a portion of a building, in a vehicle or in a craft, wherein the light source or light sources are controlled in such manner that one or more of the following characteristics of the light are altered, viz. the intensity of the light, the wavelength of the light, the frequency at which the light source or light sources are switched on and the time during which the light source or light sources are on. The invention also comprises a corresponding apparatus.

### TECHNICAL FIELD

This invention concerns a method and an apparatus for preventing illegitimate intrusion and/or staying in an area indoors or outdoors, for example in a building, in a portion of a building, in a vehicle or in a craft.

### STATE OF THE ART

Conventional alarms that are installed in order to prevent existing values from theft or damage have the disadvantage that the intruder often does not experience sufficient discomfort based on the alarm. As the discomfort experienced by the intruder often is not sufficiently great the latter can continue his or her activity and possibly also be able to complete this and disappear from the spot before anyone reacts to the alarm and before for example security guards or the police arrive.

It is known to use sound generating equipment to create discomfort to intruders, see for example patent specification SE-C2-500 818.

It is also known to utilize light generating equipment in order to create discomfort to intruders, for example by using stroboscopic light.

However, it has been found that the discomfort which is created by existing light generating equipment is not always satisfactory. In other words, it would be to advantage if the discomfort experienced by an intruder could be increased.

### SUMMARY

The purpose of this invention is to fully or partially deal with the disadvantages associated with the previously known technology.

Generally speaking, the mentioned purpose can be achieved by a method for controlling one or more light sources in order to prevent undesired intrusion and/or staying within an area outdoors or indoors. This can for example be in a building, in a portion of a building, in a vehicle or in a craft. In said method the light source or light sources are controlled such as to alter one or more of the following characteristics, viz. the intensity of the light, the wavelength of the light, the frequency at which the light source or light sources are switched on and the period of time during which the light source or light sources are on.

It can also be advantageous to alter the mentioned one or more characteristics of the light continuously.

Furthermore, it can be advantageous to alter said one or more characteristics of the light randomly.

It can also be advantageous to alter more than one characteristic of the light.

If more than one characteristic of the light is altered it can be advantageous if said characteristics of the light are altered randomly with regard to each other.

It can also be advantageous to control a plurality of light sources.

If a plurality of light sources are controlled it can be advantageous to control the light sources randomly with regard to each other.

It is also advantageous to have an apparatus for preventing unauthorized intrusion and/or staying in an area indoors or outdoors. This can for example be in a building, in portion of a building, in a vehicle or in a craft. Such apparatus can basically comprise one or more light sources with controlled means for producing light in which one or more of the following characteristics of the light are altered: the intensity of the light, the wavelength of the light, the frequency at which the light source or the light sources are switched on and off and the period of time during which the light source or light sources are on or off.

It can also be an advantage to have the apparatus comprise a plurality of light sources.

### BRIEF DESCRIPTION OF THE FIGURES

FIG. 1 shows an example of an alarm system in which the apparatus and method disclosed here are utilized.

### DETAILED DESCRIPTION

The method and apparatus disclosed here will now be described more specifically in exemplifying manner. One of the advantages of the method and apparatus described here is that the experienced discomfort can be increased.

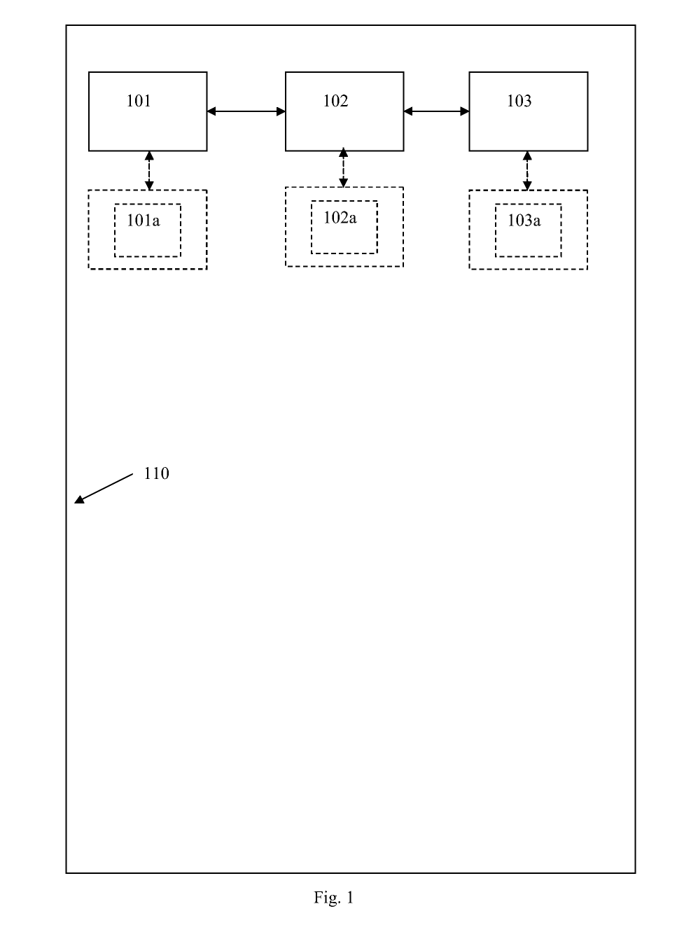

FIG. 1 shows an example of an alarm system in which the apparatus and method described here are utilized. In FIG. 1 the designation 101 refers to a detector which transmits at least one signal to a central unit 102. The central unit 102 can also send signals to said detector 101. One or more detectors 101 (shown as 101a) of the same type or different types may also be included. One or more central units 102 (shown as 102a) may be included as well. Detector 101 detects the presence of an intruder. Detector 101 can also transmit signals to the central unit 102 indicating that detector 101 has been put out of operation, for example as the result of being subjected to damage. The central unit 102 transmits control signals to a light source 103. A plurality of light sources (shown as 103a) can exist. Light source 103 can also transmit signals to the central unit 102, for example a signal indicating that the light source has been put out of operation, for instance in consequence of being damaged. The designation 110 indicates an example of an area within which unauthorized intrusion and/or staying is to be prevented.

It has turned out that by changing one or more of the elements or characteristics, the intensity of the light, the wavelength of the light, the frequency at which the light source or light sources 103 are switched on and the time during which the light source or light sources are switched on can increase the experienced discomfort to a surprising degree.

The experienced discomfort can be increased additionally by also randomly altering one or more of the mentioned elements or characteristics. Altering one or more of the mentioned characteristics or elements continuously also increases the experienced discomfort.

If a plurality of light sources 103 are utilized it is an advantage if they are controlled in such manner that they are not experienced as co-ordinated with each other. Thus, they are to be controlled randomly with regard to each other. This increases the experienced discomfort as compared to if the light sources 103 are controlled co-ordinatedly manner with regard to each other.

As the result of changing one or more of the mentioned elements or characteristics of the light or the manner in which the light sources 103 are controlled with regard to each other an intruder will find it difficult to prepare for the characteristics of the emitted light. It is not possible to become used to the light when the latter incessantly changes its character. This contributes to the increased discomfort.

By also utilizing random control the discomfort can be increased additionally, as it basically becomes impossible for an intruder to prepare himself or herself for, or to become accustomed to, the characteristics of the emitted light.

In an embodiment of the method and apparatus described here it has turned out to be advantageous to utilize light comprised of one or more wavelengths in the interval which is designated as visible light. However, it can also be advantageous to use a light source or light sources 103 which emit light of different wavelengths. For example, it could be possible for an intruder to utilize means, for instance glasses, which filter out visible light but are sensitive to infrared light. Such equipment can be used for good vision in the dark without utilizing visible light. In such case it is to advantage if the light source or light sources 103 emit infrared light as a supplement to or instead of the visible light in order to create discomfort to the intruder.

With regard to the frequency at which the light source or light sources are switched on and off, the interval of 0.5-15 Hz has turned out to be advantageous, but frequencies up to 30 Hz can also be utilized.

With regard to the period during which the light source or light sources are on, the interval of 0.1-199 milliseconds has proved to be advantageous.

With regard to the intensity of the light source or light sources this should be made sufficient for an intruder to experience discomfort. The intensity is dependent of the environment in which the light source is located, but the interval 10 candela (cd) to 500 000 cd has been shown to be advantageous. In many applications the interval 10 000 cd to 500 000 cd is advantageous. Depending on the relevant application, higher light intensities may also have to be utilized.

The electronics utilized for controlling the light source or the light sources and their possible mutual relationship are based on known technology mastered by a person skilled in the art and are not a part of the method or apparatus described here, and therefore they will not be disclosed further.

1. A method of controlling one or more light sources (103) for preventing unauthorized intrusion and/or staying within an area (110) indoors or outdoors, for example in a building, in a portion of a building, in a vehicle or in a craft, characterized in that the light source or light sources (103) are controlled such as to alter one or more of the following characteristics of the light are:
the intensity of the light, the wavelength of the light, the frequency at which the light source or light sources (103) are switched on and off and the period of time during which the light source or light sources (103) are on,
wherein at least the period of time during which the light source or light sources (103) are on is varied.

2. A method in accordance with claim 1, characterized in that said one or more characteristics of the light are altered continually.

3. A method in accordance with claim 1, characterized in that said one or more characteristics of the light are altered randomly.

4. A method in accordance with claim 1, characterized in that more than one characteristic of the light is altered.

5. A method in accordance with claim 4, characterized in that said characteristics of the light are altered randomly with respect to each other.

6. A method in accordance with claim 1, characterized by a plurality of light sources (103) being controlled.

7. A method in accordance with claim 6, characterized in that said light sources (103) are controlled at random with regard to each other.

8. Apparatus for preventing unauthorized intrusion and/or staying within an area (110) indoors or outdoors, for example in a building, in a portion of a building, in a vehicle or in a craft, characterized in that it comprises one or more light sources (103) with control means (102) for generating light in which one or more of the following characteristics of the light are altered:
the intensity of the light, the wavelength of the light, the frequency at which the light source or light sources (103) are switched on and the period of time during which the light source or light sources (103) are on,
wherein at least the period of time during which the light source or the light sources (103) are on is varied.

9. Apparatus in accordance with claim 8, characterized in that it comprises a plurality of light sources (103).
